(19) United States
(12) Patent Application Publication
(10) Pub. No.: US 2008/0234009 A1
(43) Pub. Date: Sep. 25, 2008

(54) SYSTEM AND DEVICES FOR INDUCTIVE CHARGING OF A WEARABLE ELECTRONIC DEVICE

(75) Inventors: David R. Zeiger, Mundelein, IL (US); Patrick J. Cauwels, South Beloit, WI (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/690,402

(22) Filed: Mar. 23, 2007

(51) Int. Cl. H04M 1/05; H02J 7/00

(52) U.S. Cl. 455/573; 320/108; 379/430

(57) ABSTRACT

Disclosed is a wearable electronic device including an earmount. The earmount includes an inductor configured to convert an alternating magnetic field to alternating current. The device also includes a rectifier circuit coupled to the inductor and configured to convert alternating current to direct current for trickle charging, and a rechargeable power source configured to receive from the rectifier circuit direct current for trickle charging of the power source. Also disclosed is a charger adapted for use with the wearable wireless communication device described above. The charger is configured to receive an earmount of the wearable electronic device and to electromagnetically couple to the wearable electronic device via the inductor included in the earmount. Also disclosed is a system for trickle charging of a wearable electronic device. The system may include a charger and one or more wearable electronic devices, each device including an earmount having an inductor.

### FIELD

Disclosed are a charger, a wearable electronic device, and a system for trickle charging a wearable electronic device, and more particularly, a wearable electronic device having an earmount with an inductor incorporated in the earmount for electromagnetically coupling the wearable electronic device to the charger.

### BACKGROUND

The makers of mobile communication devices, including those of cellular telephones, are increasingly adding functionality to their devices. There is also a trend toward smaller mobile communication devices. Thus, in both cellular telephones and headsets worn on a user's ear, the surface area of the housing available for connectors to their circuit boards is limited. As manufacturers continue to add features and reduce their products' size, there may be even less surface area for placement of connectors and other features.

An electric toothbrush is an example of a device with no electrical connectors which may be important since an electric toothbrush is typically used with water. Inductive charging is used recharge its batteries that are completely sealed. The toothbrush rests on the charger without any metal contacts to connect the toothbrush to the base. The toothbrush and the base form a two-part transformer, with the base having one part of the transformer and the toothbrush having the other. The base contains the primary coil of the transformer and a magnetic core. The toothbrush contains the secondary coil of the transformer. When the toothbrush is mounted on the base, the complete transformer is created. The induction coil of the base creates an alternating electromagnetic field across the surface of the base. The induction coil in the toothbrush takes power from the field and converts it back into electrical current to charge the toothbrush battery. The electronics of a toothbrush housed in the toothbrush housing can be minimal, including only a motor, a rectifier circuit, a switch, and a battery. The toothbrush housing may be large and have minimal electronics since it is for use as a toothbrush. Therefore, the size of the inductive coil and ferrite core in a toothbrush may not be important.

### BRIEF DESCRIPTION OF THE DRAWINGS

FIG. 1 shows a wearable electronic device including a housing and an earmount coupled to the housing;

FIG. 2 illustrates circuitry included within the housing of the device of FIG. 1;

FIG. 3 shows a ferrite core surrounded by a set of first windings and a set of second windings;

FIG. 4 shows another configuration in which a transformer may be formed;

FIG. 5 shows a charger configured to receive the wearable electronic device for trickle charging of the power source;

FIG. 6 depicts an embodiment of a system for trickle charging of a wearable electronic device;

FIG. 7 depicts a wearable electronic device in position in a charger for trickle charging, with an earmount received within the internal volume of the charging core;

FIG. 8 depicts an embodiment of a wearable electronic device having a housing and an earmount coupled to the housing;

FIG. 9 shows an end-on view of the device of FIG. 8 to illustrate how the earmount is rotatably coupled to the housing by the hinge; and

FIG. 10 shows a charging wand, on which a plurality of wearable electronic devices may be positioned by their respective earloops for trickle charging.

### DETAILED DESCRIPTION

In general, inductive charging is not considered an option for portable electronics, in particular wireless communication devices such as cellular telephones and headsets, because the size of a coil and ferrite core may considered too large in light of the reduced size of the wireless communication devices.

Disclosed is a wearable electronic device capable of being positioned in a wearable position adjacent a user's head and configured for inductive charging. The wearable electronic device may include a housing and an earmount coupled to the housing. The earmount can have any suitable shape, including an arcuate shape of an earhook or an earloop. In this way, the earmount can make a wearable electronic device, which may be a wireless communication device such as a cellular telephone or a headset, an over-the-ear device that may be convenient to use.

The earmount may be configured so that it includes an overhanging, lower, or extended portion and a hinge portion, the hinge portion coupling the earmount to the housing. The overhanging portion of the earmount may be convenient for a user to find and thus may facilitate situating the device over the ear. The overhanging portion may hang over the user's ear when positioned adjacent a user's head, and over the user's ear. The overhanging portion of the earmount may be stable, even when touched by the user because of the manner in which it may hang down from the ear from which it is secured.

As will be described in more detail below, disclosed is a wearable electronic device including an earmount that includes an inductor configured to convert an alternating magnetic field to alternating current. The wearable electronic device also includes a rectifier circuit supported by the housing of the wearable electronic device, the rectifier circuit being coupled to the inductor and configured to convert alternating current to direct current for trickle charging. A rechargeable power source is supported by the housing, the power source coupled to the rectifier circuit and configured to receive from the rectifier circuit direct current for trickle charging of the power source. Also disclosed is a charger with a mating base to receive the earmount for inductive charging.

As mentioned above, inductive charging is not considered an option for portable electronics, and in particular, not for small wireless communication devices since windings and a ferrite core would add too much bulk to the device. The structure and size of the transformer created by the inductive charging elements, however, in combination with an earmount of a wearable electronic device and the mating base, may provide benefits. Inductive charging, while slower than charging by an adapter, can free valuable surface area of a small device from connector requirements of a charger.

As mentioned above, also disclosed is a charger adapted for use with the wearable wireless communication device described above. The charger is configured to receive an earmount of the wearable electronic device and to electromagnetically couple to the wearable electronic device via the inductor included in the earmount. In one embodiment the charger includes a charging cradle having a charging core with an internal volume accessible to the earmount. In another embodiment the charger includes a charging wand adapted to receive and support earmounts of one or a plurality of wearable electronic devices. In the event that overheating the electronics of the wireless communication device were a concern, the charger configuration may act to shield or isolate the electronics of the wearable electronic device from the heat generated by the inductive charging.

Also disclosed is a system for trickle charging of a wearable electronic device. The system may include one or more wearable electronic devices, each device including an earmount having an inductor. The system may also include a charger adapted to receive an earmount of a wearable electronic device, and to provide an alternating magnetic field to be converted by the inductor of the earmount into alternating current. A rectifier circuit in the wearable electronic device may convert the alternating current to direct current for charging a rechargeable power source of the wearable electronic device.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

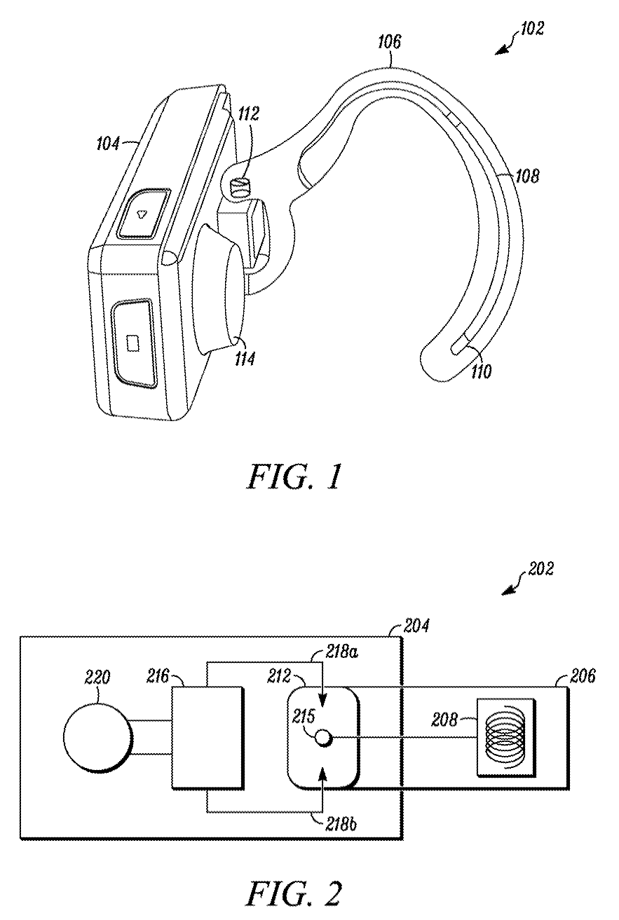

FIG. 1 shows a wearable electronic device 102 including a housing 104 and an earmount 106, configured for inductive charging, coupled to the housing 104. The earmount 106 may include an inductor 108 configured to convert an alternating magnetic field to alternating current. The earmount 106 may for example be an earhook which may have an arcuate shape. The inductor 108 may include a wirewound ferrite core 110, and may be curved to follow the arcuate shape of the earhook. In this way, there may be no need for a connector for charging since the inductive charging elements may be sealed within the earmount. Valuable surface area of the wearable electronic device may be therefore conserved. Moreover, if heat were a concern, heat generated by the inductive charging may be dissipated away from sensitive electronics of the wearable electronic device since the earmount 106 is distal the housing 104.

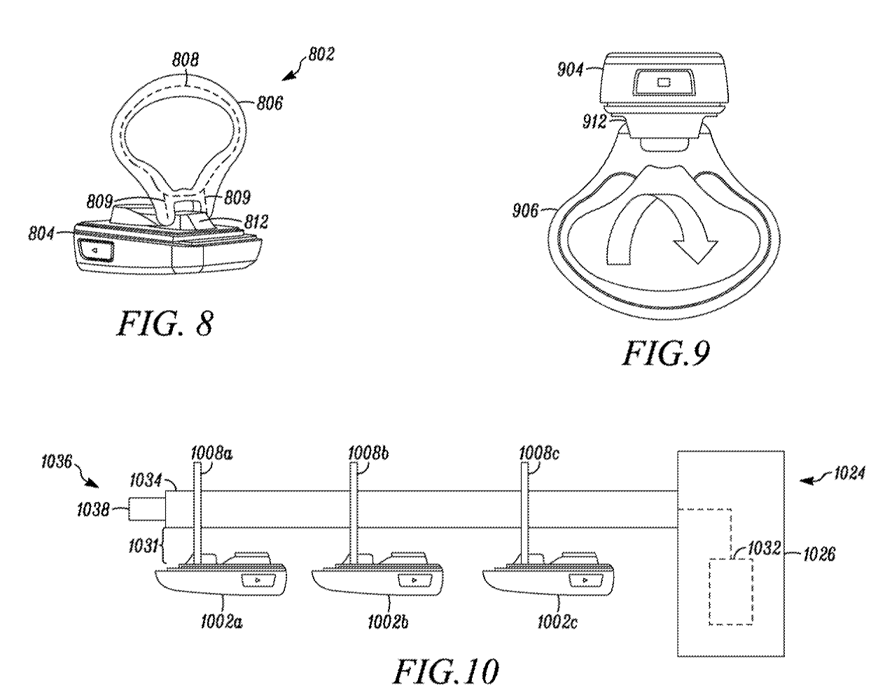

The earmount 106 may be rotatably and/or detachably coupled to the housing 104 via a hinge 112. The hinge 112 may provide both mechanical and electrical coupling between the earmount 106 and the housing 104. The inductor 108 may be electrically connected to circuitry within the housing 104 by an electrical connection that can be incorporated in the hinge 112. The housing 104 may support additional components of the device 102, such as, for example, a speaker 114. It is understood that other configurations for the earmount and inductor are possible. Another earmount embodiment is discussed below in connection with FIGS. 8-10.

It is understood that the wearable electronic device 102 may be implemented as a wireless communication device such as a cellular telephone (also called a mobile phone) or a headset or other type of earworn device. The mobile communication device 102 represents a wide variety of devices that have been developed for use within various networks. Such communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

FIG. 2 illustrates circuitry that may be included within the housing 204 (corresponding to housing 104 of FIG. 1) to transfer energy collected by the inductive charger to a power source 220. As discussed above, the hinge 212 may provide both mechanical and electrical coupling between housing 204 and the earmount 206 and inductor 208. An electrical connection between the inductor 208 and circuitry in the housing can be made 215 through the hinge 212. A rectifier circuit 216 may be supported within the housing 204, and can be configured to receive alternating current from the inductor 208 and to convert it to direct current. The rectifier circuit 216 may be coupled to the inductor 208 through conductors 218a and 218b configured to make an electrical connection with the inductor 208 through the hinge 212 and electrical connection 215. Direct current output from the rectifier circuit 216 may be provided to a rechargeable power source 220, which may be for example, a battery. In this manner inductive charging of the power source 220 may be accomplished when the inductor 108 is in proximity to an appropriate alternating magnetic field. The alternating magnetic field may be, for example, configured for trickle charging of the power source 220 through the inductor 208 and rectifier circuit 216. Additional circuitry may be coupled to the power source 220 to provide functioning of the wearable electronic device 202.

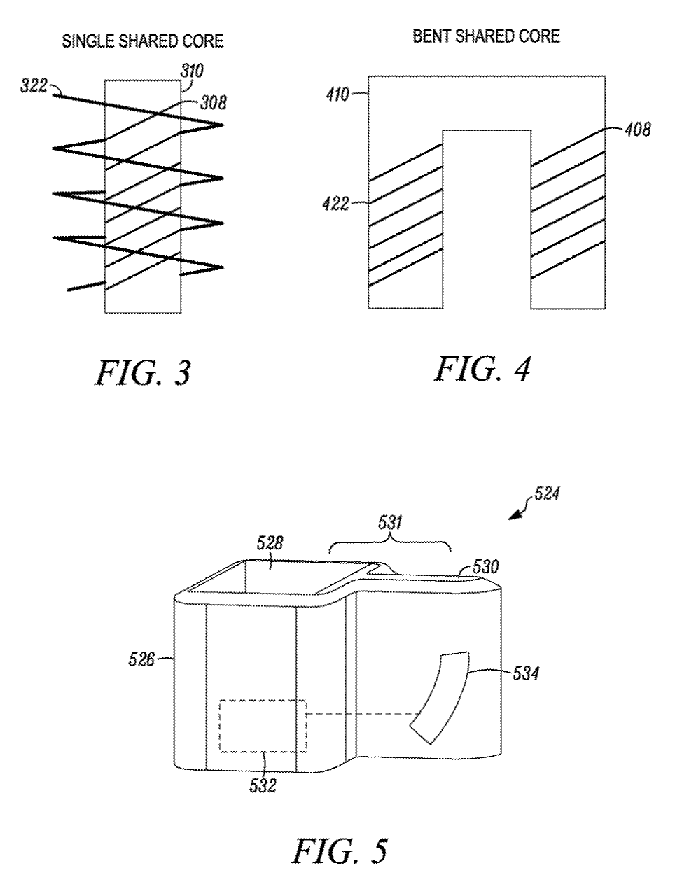

FIG. 3 shows a ferrite core 310 surrounded by a set of first windings 308 and a set of second windings 322. A set of windings may form an inductor. The terms windings and inductor may be used interchangeably. The ferrite core can strengthen the magnetic field within the windings of the inductor. In this disclosure the first windings 308 are referred to as an inductor 308 as well. Similarly, the second windings 322 may be referred to as an inductor 322.

The ferrite core 310 and the first windings 308 are positioned within the earmount 106 (see FIG. 1). The shape of the earmount 106 may be conducive to supporting the first winding. Were a winding to be positioned on the main housing of a wireless communication device, valuable space of the otherwise small device would be occupied by the bulk of a winding. The second windings 322 may be positioned within a charger 524 (see FIG. 5, below). Together the first windings 308 and the second windings 322 may form a transformer. Accordingly, FIG. 3 illustrates schematically the configuration the earmount 106 may have when placed within a charger. As mentioned, the inductor 308 of the earmount 106 includes a wirewound ferrite core 310. A corresponding inductor 322 of the charger may include windings coupled to an alternating current power source and may be configured to generate an alternating magnetic field. The inductor 322 and the inductor 308 together can form a transformer by which power can pass from the inductor 322, acting as a primary coil of the transformer, to inductor 308, acting as a secondary coil of the transformer. The ferrite core 310 improves the power transfer characteristics of the configuration by enabling the inductor 322 to create a stronger magnetic field in the proximity of the inductor 308. As shown, substantially the same volume of the ferrite core 310 is contained interior to each of inductor 308 and inductor 322. It is understood that other configurations of the ferrite core 310 with respect to the inductor 308 and the inductor 322 are possible.

FIG. 4 shows another configuration in which a transformer may be formed. As shown, an inductor 422, acting as a primary coil, can be configured to provide power via transformer action to an inductor 408, acting as a secondary coil. A ferrite core 410 can improve the power transfer characteristics of the configuration. In this configuration, the two inductors 408 and 422 need not share the same volume of ferrite core, but can be displaced one from the other. The ferrite core 410 can be bent in the shape shown, or may be configured in any suitable shape. It will be appreciated that with an appropriate shape and configuration for the ferrite core 410, multiple secondary coils can be provided power by the same primary coil 422.

FIG. 5 shows a charger device 524 configured to receive the wearable electronic device 102 (see FIG. 1) for trickle charging of the power source 220 (see FIG. 2). The charger 524 can include a housing 526. The housing may be shaped so as to form a receptacle 528 or charging cradle configured to receive the wearable electronic device 102 (see FIG. 1). The housing 526 may further define a cavity 530 shaped to receive an earmount 106 of the wearable electronic device 102. Therefore, were heat generated by the inductive charging a concern, a distance 531 between the heat generated by the inductive charging and the electronics of the wearable electronic device 102 may be maintained. Since there is a distance 531 between the electronics of the device 102 and the inductive charger supported by the earmount 106 of the device 102, it may be possible to charge the device 102 at a faster rate than were the winding and ferrite core within the same housing as the electronics of device 102. In this way, since heat may be generated by charging more quickly, the distance 531 separating the main housing from the inductive charging components may beneficially allow a faster charge.

The housing 526 of the charger 524 can support a charging regulator 532 positioned within the housing and configured to provide alternating current. The charger 524 may receive such alternating current from any suitable source such as a public utility. A charging core 534 is disposed within, and supported by, the housing 526 (see 322, FIG. 3). The charging core 534 may be coupled to the charging regulator 532 and configured to generate an alternating magnetic field from alternating current provided by the charging regulator. The charging core 534 may be positioned with respect to the cavity 530 so that the charging core may receive the earmount 106. The charging core 534 may thereby provide an internal volume accessible to the earmount 106 within which the earmount may be received.

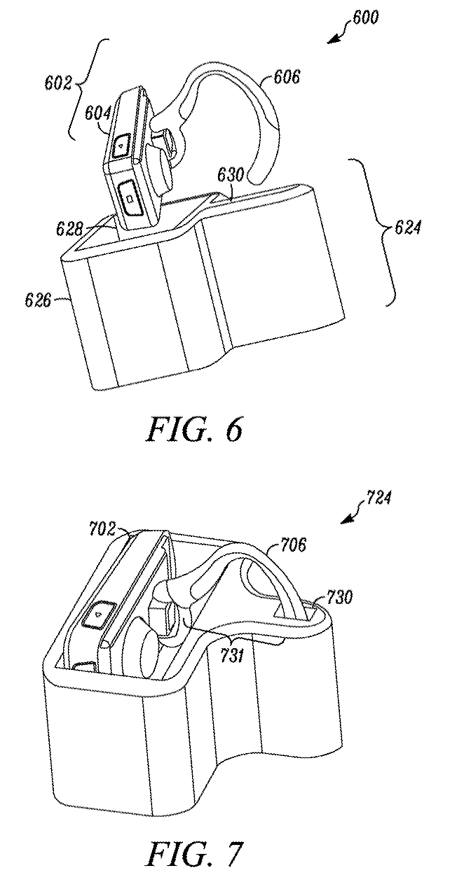

FIG. 6 depicts an embodiment of a system 600 for trickle charging of a wearable electronic device 602. The system 600 may further include a charger 624. The combination of device 602 and charger 624 may form a charging system. The wearable electronic device 602 may include a housing 604 and an earmount 606, shown as an earhook in the drawing. The charger 624 may include a housing 626 including a charging cradle 628 and a charging core incorporating a cavity 630 to allow reception of the earmount 606 within an internal volume of the charging core. As shown in the drawing, the wearable electronic device 602 may be placed in the charging cradle 628 with the earmount 606 received within the charging core via the cavity 630.

FIG. 7 depicts a wearable electronic device 702 in a position within a charger 724 for trickle charging, with an earmount 706 received within the internal volume of the charging core via the cavity 730. As mentioned above, the charger may receive alternating current from any suitable source such as a public utility. In this manner the system 600 (see FIG. 6) may accomplish trickle charging of the wearable electronic device 602. As discussed above, if heat were a concern, the charger may be configured to provide shielding and isolation by maintaining a distance 731 between the heat generated by the inductive charging and the electronics of the wearable electronic device 702.

FIG. 8 depicts an embodiment of a wearable electronic device 802 having a housing 804 and a loop shaped earmount 806 coupled to the housing 804. The earloop 806 may be rotatably and/or detachably coupled to the housing 804 by a hinge 812. The earmount 806 may include an inductor 808, a circumferentially wound coil within the earloop 806 and electrically connected, for example, by conductors 809, to the hinge and thence for example by conductors 218a and 218b (see FIG. 2) to a rectifier circuit 216. As in the previously illustrated embodiment of FIG. 2, the wearable electronic device may further include a power source 220 coupled to the rectifier circuit 216 for trickle charging.

FIG. 9 shows an end-on view of the device 802 (see FIG. 8) to illustrate how the earmount 906 can be rotatably coupled to the housing 904 by the hinge 912. A cam and cam follower, or other tensioning device, may be incorporated in the hinge 912 to enable the earloop 906 to be held in a particular position relative to the housing 904, for example, perpendicular to the long dimension of the housing. It is understood that any shaped earmount and any coupling configuration for coupling an earmount to a housing including inductive charging elements is within the scope of this discussion.

FIG. 10 shows a charging wand 1036, on which a plurality of wearable electronic devices 1002a, 1002b, and 1002c may be positioned by their earloops 1008a, 1008b, and 1008c, respectively, for trickle charging. If heat were a concern, the wand charger configuration may also provide sufficient distance 1031 between the devices 1002a, 1002b, and 1002c and the inductive charging, to avoid overheating the devices' electronics. The charging wand 1036 acts in the capacity of a charging core, and is a portion of a charger 1024 that includes a housing 1026 supporting the charging core 1036. FIG. 10 illustrates a configuration for a charger 1024 and wearable electronic device 1002a, in which an earmount 1008a includes a shape configured to be mounted on and supported for charging by the charger. It is understood that the embodiment of FIG. 10 is not limited to simultaneous charging of three devices 1002a, 1002b, and 1002c.

In the configuration of FIG. 10, a charging regulator 1032 is supported by the housing 1026, and electrically coupled to the charging core 1036. The charging regulator 1032 is configured to provide alternating current to the charging core 1036. As previously mentioned, the charger may receive such alternating current from any suitable source such as a public utility. The charging core includes an inductor 1034 and is configured to generate an alternating magnetic field from alternating current it receives from the charging core 1036. In an embodiment, multiple wearable electronic devices may be charged at the same time by one charger. In the event that heat generated by the inductive charging were a concern in the configuration of FIG. 10, the charger may be configured to maintain a distance 1031 between the heat generated by the inductive charging and the electronics of each of the wearable electronic devices 1002a, 1002b, and 1002c.

Disclosed are a charger, a wearable electronic device, and a system for charging a wearable electronic device. The system includes an inductive charger that may provide a configuration that can avoid the bulk of an inductive coil and ferrite core within a main housing of a wireless device by supporting the inductive coil and ferrite core within the earmount. The charger is configured to receive the earmount and to regulate an alternating magnetic field provided by the charger to the inductor. With the reduced surface area of smaller devices and a trend toward inclusion of more features, and in particular earmounted devices, having fewer connectors occupying surface area may be beneficial.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A wearable electronic device, comprising:
a housing;
an earmount coupled to the housing, the earmount including an inductor configured to convert an alternating magnetic field to alternating current;
a rectifier circuit supported by the housing, the rectifier circuit coupled to the inductor and configured to convert alternating current to direct current for trickle charging; and
a rechargeable power source supported by the housing, the power source coupled to the rectifier circuit and configured to receive from the rectifier circuit direct current for trickle charging of the power source.

2. The device of claim 1, wherein the earmount comprises an earhook.

3. The device of claim 2, wherein the inductor comprises a wirewound ferrite core.

4. The device of claim 1, wherein the inductor is positioned in the earmount, the rectifier is positioned in the housing, and the power source is positioned in the housing, and wherein the inductor is coupled to the rectifier via an electrical connection incorporated in a hinge rotatably coupling the earmount to the housing.

5. The device of claim 1, wherein the earmount comprises an earloop.

6. The device of claim 5, wherein the inductor comprises a circumferentially wound coil.

7. The device of claim 1, wherein the earmount is rotatably coupled to the housing.

8. The device of claim 1, further comprising a cellular telephone.

9. The device of claim 1, wherein the earmount comprises a shape configured to be mounted on, and supported by, a charger.

10. A charger for charging a wearable electronic device, the charger comprising:
a housing;
a charging regulator supported by the housing and configured to provide alternating current; and
a charging core supported by the housing and coupled to the charging regulator, the charging core configured to generate from alternating current an alternating magnetic field,
wherein the charging core of the charger is configured to receive an earmount of a wearable electronic device.

11. The charger of claim 10, further comprising a charging cradle configured to support the charging core, wherein:
the charging core has an internal volume accessible to the earmount; and
the charging core is configured to receive the earmount within the volume.

12. The charger of claim 10, further comprising a charging wand configured to receive and support earmounts of a plurality of wearable electronic devices.

13. A system for trickle charging of a wearable electronic device, comprising:
a wearable electronic device comprising:
a first housing;
an earmount coupled to the first housing, the earmount including an inductor configured to convert an alternating magnetic field to alternating current;
a rectifier circuit supported by the first housing, the rectifier circuit coupled to the inductor and configured to convert alternating current to direct current for trickle charging; and
a rechargeable power source supported by the first housing, the power source coupled to the rectifier circuit and configured to receive from the rectifier circuit direct current for trickle charging of the power source; and
a charger comprising:
a second housing;
a charging regulator supported by the second housing and configured to provide alternating current; and
a charging core supported by the second housing and coupled to the charging regulator, the charging core configured to generate from alternating current an alternating magnetic field,
wherein the charging core of the charger is configured to receive the earmount.

14. The system of claim 13, wherein the earmount comprises an earhook.

15. The system of claim 13, wherein the inductor comprises a wirewound ferrite core.

16. The system of claim 13, wherein the charger comprises a charging cradle and the charging core has an internal volume accessible to the earmount, and wherein the charging core is configured to receive the earmount within the volume.

17. The system of claim 13, wherein the earmount comprises an earloop.

18. The system of claim 13, wherein the inductor comprises a circumferentially wound coil.

19. The system of claim 13, wherein the charger comprises a charging wand configured to receive a plurality of earmounts.

20. The system of claim 13, wherein the earmount is rotatably coupled to the first housing.
